(19) United States
(12) Patent Application Publication
(10) Pub. No.: US 2017/0356602 A1
(43) Pub. Date: Dec. 14, 2017

(54) LED BULB STRUCTURE

(71) Applicant: Chin-San Lin, Taipei City (TW)

(72) Inventor: Chin-San Lin, Taipei City (TW)

(21) Appl. No.: 15/181,424

(22) Filed: Jun. 14, 2016

(51) Int. Cl. F21K 9/238; F21V 3/04; F21K 9/232; F21V 25/04; F21Y 2115/10

(52) U.S. Cl. CPC F21K 9/238; F21K 9/232; F21V 25/04; F21V 3/0418; F21Y 2115/10

(57) ABSTRACT

An LED bulb structure includes a glass envelope, support, LED light emitting body, tungsten filament light emitting body and electronic element units, where the glass envelope is vacuum-sealed, the support formed by a conducting wire is fixed inside it, both LED and tungsten filament light emitting bodies are configured on the support, the necessary electronic element units are configured on the support between the LED light emitting body and tungsten filament light emitting body, and one side of the support is set to a positive pole and another side thereof a negative pole. As arranged, air will enter the glass envelope of a broken LED bulb to cause the tungsten filament to be burned to break to extinguish, and thus to cause the LED light emitting body to extinguish in such a way to remind users that the broken LED bulb must be replaced with a new one.

### TECHNICAL FIELD OF THE INVENTION

The present invention relates to an LED bulb structure, and more particularly to an LED Christmas bulb or general lighting bulb structure.

### DESCRIPTION OF THE PRIOR ART

LED bulbs mentioned in this specification are Christmas bulbs or general lighting bulbs with a glass envelope. Such kinks of LED bulbs available in the current market are only installed with one or more LED light emitting bodies for light emitting purpose. But, if the glass envelope of such kind of LED bulb is broken and is still lighted up without replacement due to negligence or unawareness, probably resulting in electricity leakage due to the inflow of water and cutting people due to the broken parts of the glass envelope. Therefore, conventional LED bulb structures with a glass envelope are still not ideal, required to improve.

### SUMMARY OF THE INVENTION

An LED bulb structure of the present invention is mainly constituted by a glass envelope, support, LED light emitting body, tungsten filament light emitting body and electronic element units, where the glass envelope is vacuum-sealed and is filled with gas or no gas. The support formed by a conducting line is fixed inside the glass envelope, both the LED light emitting body and tungsten filament light emitting body are connected with the support, and the necessary electronic element units are configured on the support between the LED light emitting body and tungsten filament light emitting body. Furthermore, one side of the support is set to a positive pole and another negative pole. As arranged, one side of power source (positive pole or negative pole) must be turned on to light LED light emitting body 30 through the tungsten filament light emitting body 40, while the tungsten filament light emitting body will emit light because power source is turned on or not emit light even if the power source is turned on. Air will enter the glass envelope of an LED bulb when it is broken. At this time, the tungsten filament will be burned by itself to melt or break to extinguish because oxygen molecules in the air act the tungsten filament physically and chemically to cause it to have a high temperature due to molecular oxygen oxidation combustion-supporting, leaving the support form an open circuit to interrupt the power source to cut off the power supply to the LED light emitting body to cause it to extinguish in such a way to remind users that it is the time to replace it with a new one.

### BRIEF DESCRIPTION OF THE DRAWINGS

FIG. 1 is a schematic view of an LED bulb structure according to the present invention; and

FIG. 2 is a schematic view of an LED bulb structure according to the present invention while a glass envelope is broken.

### DETAILED DESCRIPTION OF THE PREFERRED EMBODIMENTS

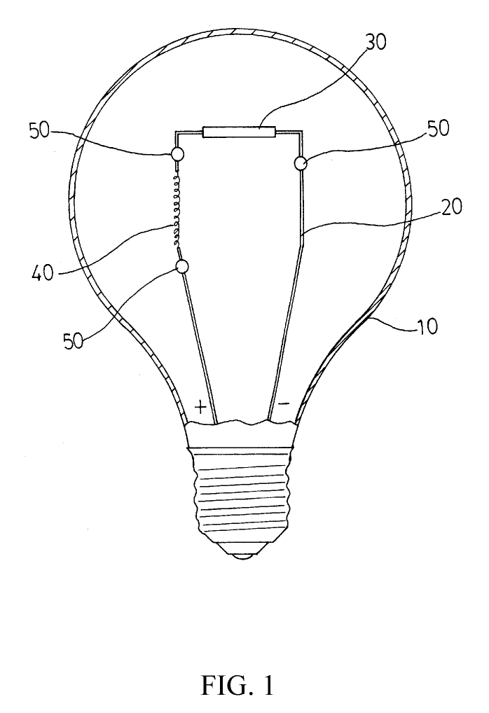

Referring to FIG. 1, an LED bulb structure of the present invention is mainly constituted by a glass envelope 10, support 20, LED light emitting body 30, tungsten filament light emitting body 40 and electronic element units 50, where the glass envelope 10 is vacuum-sealed and is filled with gas (a uncertain amount of inert gas) or no gas. The support 20 formed by a conducting line is fixed inside the glass envelope 10, both the LED light emitting body 30 and tungsten filament light emitting body 40 are connected with the support 20, and the necessary electronic element units 50 are configured on the support 20 between the LED light emitting body 30 and tungsten filament light emitting body 40. Furthermore, one side of the support 20 is set to a positive pole and another negative pole. As arranged, one side of power source (positive pole or negative pole) must be turned on to light LED light emitting body 30 through the tungsten filament light emitting body 40, while the tungsten filament light emitting body 40 will emit light because power source is turned on (or not emit light even if the power source is turned on).

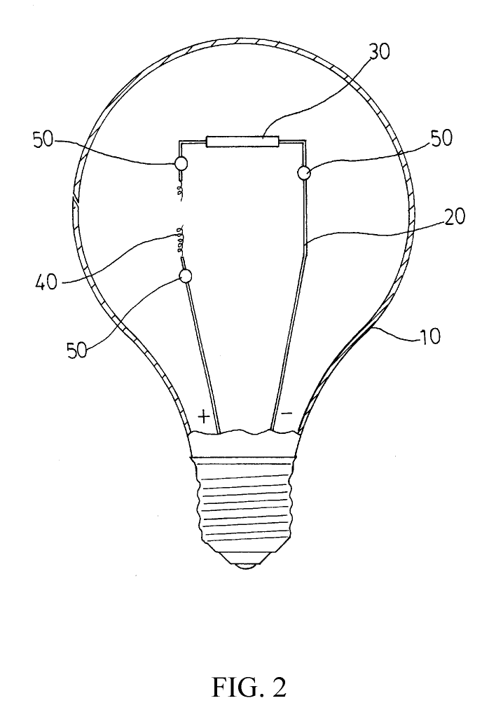

Next, referring to FIG. 2, air will enter the glass envelope 10 of an LED bulb when it is broken. At this time, the tungsten filament 40 will be burned by itself to melt or break to extinguish because oxygen molecules in the air act the tungsten filament 40 physically and chemically to cause it to have a high temperature due to molecular oxygen oxidation combustion-supporting, leaving the support 20 form an open circuit to interrupt the power source to cut off the power supply to the LED light emitting body 30 to cause it to extinguish in such a way to remind users that the LED bulb has structural defects and it is the time to replace it with a new one, thereby facilitating the users to cultivate a use habit that an LED bulb must be replaced immediately when it is not bright as done in general tungsten vacuum bulbs to ensure that an LED bulb with a broken glass envelope can be noticed and replaced immediately.

I claim:

1. An LED bulb structure, comprising a glass envelope, support, LED light emitting body, tungsten filament light emitting body and electronic element units, said glass envelope being vacuum-sealed and being filled with gas (a uncertain amount of inert gas) or no gas, said support formed by a conducting wire being fixed inside said glass envelope, both said LED light emitting body and tungsten filament light emitting body being configured on said support, said necessary electronic element units being configured on said support between said LED light emitting body and tungsten filament light emitting body, and one side of said support being set to a positive pole and another side thereof a negative pole.

2. The structure according to claim 1, wherein said LED light emitting body is constituted by one LED or a plurality of LED in series or in series and parallel.

3. The structure according to claim 1, wherein said gas filled in said vacuum-sealed glass envelope is a uncertain amount of inert gas or gas exclusive of oxygen molecules.

4. The structure according to claim 1, wherein said electronic element units are configured to meet the rectification and decompression need between said tungsten filament light emitting body and LED light emitting body, each being a resistor, capacitor or diode, all said electronic element units are combined to make both said light emitting bodies compatible.
